(19) United States
(12) Patent Application Publication
(10) Pub. No.: US 2012/0125509 A1
(43) Pub. Date: May 24, 2012

(54) PNEUMATIC TIRE

(75) Inventors: Francois Pierre Charles Gerard Georges, Stavelot (BE); Bernard Robert Nicolas, Arlon (BE); Vincent Benoit Mathonet, Habay la Neuve (BE); Roland Willibrord Krier, Wasserbillig (LU)

(73) Assignee: THE GOODYEAR TIRE & RUBBER COMPANY, Akron, OH (US)

(21) Appl. No.: 13/238,592

(22) Filed: Sep. 21, 2011

Related U.S. Application Data
(60) Provisional application No. 61/416,482, filed on Nov. 23, 2010.

(51) Int. Cl. B60C 9/28

(52) U.S. Cl. 152/538

(57) ABSTRACT

A pneumatic tire comprises a tread, a carcass and a belt structure interposed between the carcass and the tread. The belt structure includes a zigzag belt structure formed of at least two layers of cords interwoven together from a strip of rubber reinforced with one or more cords. The strip forming the zigzag belt structure is layed up in a winding pattern in accordance with the following formula: for i=1 through L, the ith winding pattern is: [W_{L-(i-1)}Wᵢ]×N for each drum revolution, wherein L is the number of different amplitudes used to define the zigzag cycle and L≧2, and N is the number of zigzag cycles per drum revolution and N is either an integer ≧1 or N=½ⁿ wherein n is an integer ≧1.

This application claims the benefit of, and incorporates by reference, U.S. Provisional Application No. 61/416,482, filed on Nov. 23, 2010.

### FIELD OF THE INVENTION

This invention relates to a pneumatic tire having a carcass and a belt reinforcing structure, and, more particularly, to radial ply tires for use in aircraft, trucks and other high load applications.

### BACKGROUND OF THE INVENTION

In tires that have heavy loads such as truck tires or aircraft tires, zigzag belt layers have been utilized for the belt package. Zigzag belt layers eliminate cut belt endings at the shoulder. An exemplary portion of a tire with a zigzag belt layer 5 is shown in FIG. 1. The advantage of zigzag belt layers is that there are no cut belt edges near the shoulder, which greatly improves tire durability. The disadvantage to zigzag belt layers is that at the edges near the shoulder, there are overlapping layers. In some areas there are too many layers, such as 4 or more layers typically, and even 6 or more layers in some locations. The reduction of overlapping strips in the shoulder area has been shown to improve durability. Thus it is desired to have a tire with improved belt edge durability without excess weight.

### SUMMARY OF THE INVENTION

The invention provides in a first aspect a pneumatic tire comprising a tread, a carcass and a belt structure interposed between the carcass and the tread, wherein the belt structure includes a zigzag belt structure formed of at least two layers of cords interwoven together from a strip of rubber reinforced with one or more cords, wherein the strip forming the zigzag belt structure is layed up in a winding pattern in accordance with the following formula: for i=1 through L, the ith winding pattern is: [W_{L-(i-1)}Wᵢ]×N for each drum revolution, wherein L is the number of different amplitudes used to define the zigzag cycle and L≧2, and N is the number of zigzag cycles per drum revolution and N is either an integer ≧1 or N=½ⁿ wherein n is an integer ≧1.

In case of N=2 and L=2, the belt structure includes a zigzag belt structure formed of at least two layers of cords interwoven together from a strip of rubber reinforced with one or more cords, wherein the strip forming the zigzag belt structure is layed up in a first zigzag winding pattern per drum revolution, wherein the first winding pattern has the sequence W2W1 repeated 2 times, wherein W1 is a first amplitude and W2 is a second amplitude different than the first amplitude, said zigzag belt structure further comprising a second winding pattern having the sequence W1W2 repeated 2 times.

In case of N=4 and L=3, the belt structure includes a zigzag belt structure formed of at least two layers of cords interwoven together from a strip of rubber reinforced with one or more cords, wherein the strip forming the zigzag belt structure is layed up in a first zigzag winding pattern per drum revolution, wherein the first winding pattern has the sequence W3W1 and is repeated 4 times per drum revolution and a second winding pattern having a sequence W2W2 repeated 4 times per drum revolution, and a third winding pattern having a sequence W1W3 repeated 4 times per drum revolution, wherein W1 is a first amplitude and W2 is a second amplitude different than the first amplitude, and W3 is a third amplitude different than the first and second amplitude.

The belt structure may include the zigzag belt alone or together with a pair of preferably crossed working belts, wherein the angles of the working belts range from about 15 degrees to about 30 degrees. The working belts may be on top or below the zigzag belt structure. In one aspect of the invention, the axial width of the crossed working belts is lower than the axial width of the zigzag belt such as 80% to 95% of the zigzag belt width. In an other aspect of the invention, the axial width of the crossed working belts is larger than the axial width of the zigzag belt such as 101% to 115% of the zigzag belt width.

The belt structure may further include the zigzag belt together low angle belt wherein the angle of the low angle belt is in a range of from 0 degrees to 10 degrees such as 1 degree. The low angle belt may be on top or below the zigzag belt. In one aspect of the invention, the axial width of the low angle belt is lower than the axial width of the zigzag belt such as 50% to 80% of the zigzag belt width. In an other aspect of the invention, the axial width of the low angle belt is larger than the axial width of the zigzag belt such as 101% to 115% of the zigzag belt width.

### DEFINITIONS

“Axial” and “axially” mean lines or directions that are parallel to the axis of rotation of the tire.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Footprint” means the contact patch or area of contact of the tire tread with a flat surface at zero speed and under normal load and pressure

“Winding” means the pattern of the strip formed in a first revolution of the strip around a tire building drum, tire or core.

### BRIEF DESCRIPTION OF THE DRAWINGS

The invention will be described by way of example and with reference to the accompanying drawings in which:

FIG. 1 is a schematic sectional view of part of a prior art tire having a zigzag belt;

FIG. 2 illustrates a partial cross-section of an exemplary radial tire 10 of the present invention;

FIG. 3 is an example of a tire building drum showing the belt of the present invention being formed;

FIG. 4 is a first embodiment of a zigzag belt configuration;

FIG. 5 is a second embodiment of a zigzag belt configuration; and

FIG. 6 is a third embodiment of a zigzag belt configuration.

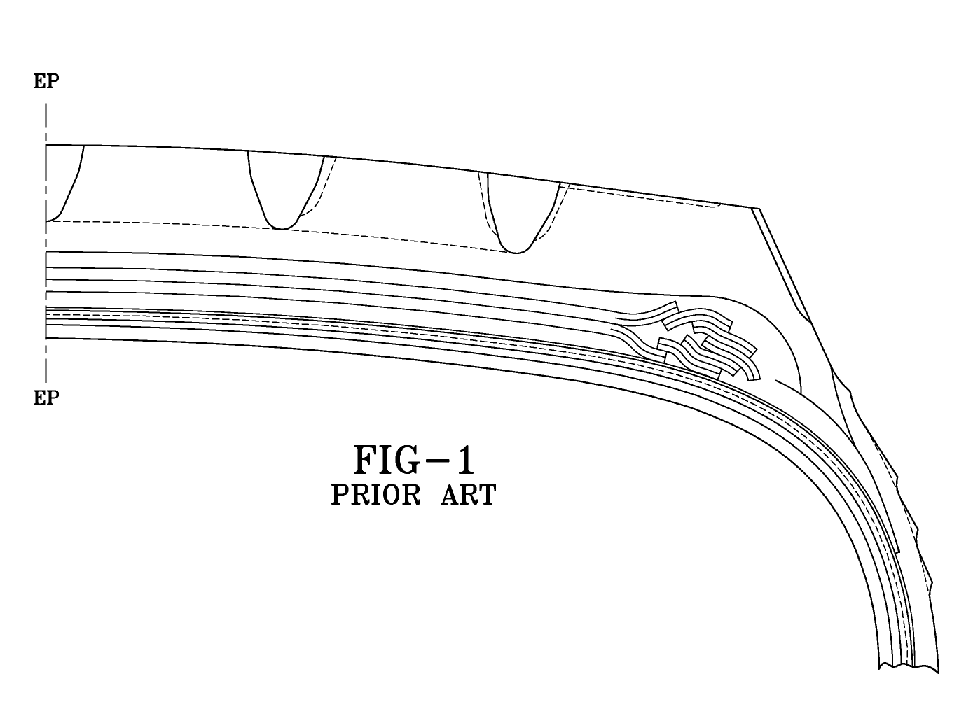

### DETAILED DESCRIPTION OF AN EXAMPLE EMBODIMENT THE INVENTION

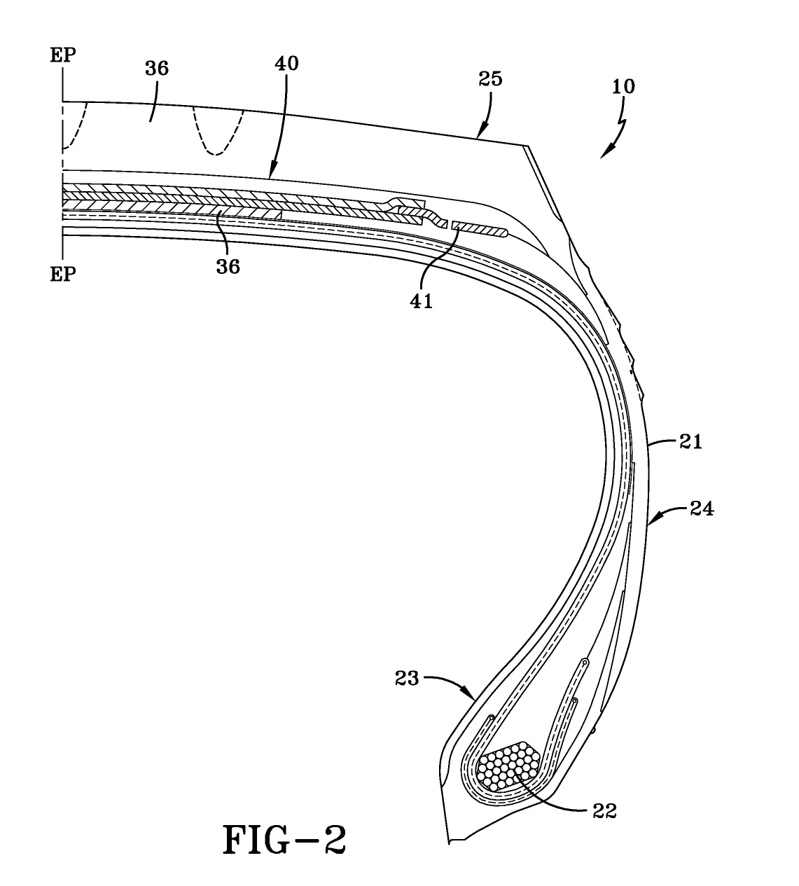

FIG. 2 illustrates a partial cross-section of an exemplary radial tire 10 which includes a bead portion 23 having a bead core 22 embedded therein, a sidewall portion 24 extending radially outward from the bead portion 23, and a cylindrical tread portion 25 extending between radially outer ends of the sidewall portions 24. The tire 10 is reinforced by a carcass 31 toroidally extending from one bead portion 23 to the other bead portion 23′ (not shown). The carcass 31 may include at least one carcass ply 32. The carcass ply 32 is anchored to the bead core and for example, may wind around each bead core 22 from inside of the tire 10 away from the equatorial plane EP to form turnup portions. A belt reinforcement package 40 is arranged between the carcass 31 and the tread portion 25.

The belt reinforcement package 40, according to an example embodiment of the present invention, includes a low angle belt 36. Belt 36 has a width in the range of about 50% to about 100% of the tread arc width, more preferably 51-75%. The breaker angle of belt 36 is between about 0 and 10 degrees, preferably with a left orientation, more preferably in the range of about 0 to about 5 degrees. The belt angles are measured with respect to the circumferential direction. Belt 36 is preferably made of steel formed in a high elongation construction such as, for example, 3×7×0.22 HE, and having an EPI in the range of about 1 to about 18. The high elongation wire may have a % elongation at 10% of the breaking load ranging from about 1.7-2.05% for a bare, green cord. The high elongation wire may have a % elongation at 10% of the breaking load ranging from about 0.45-0.68% taken from cured tire. Another example of a cord construction suitable for the invention is made of steel having a 4×7×0.26 HE construction, with an EPI of 18.

In a preferred embodiment, however, the belt reinforcement package 40 does not include the low angle belt 36.

The belt structure 40 comprises a zigzag belt structure 39 which is preferably located radially outward of the low angle belt 36, if there is such a low angle belt 36. However, as explained above, the belt structure does not include such a low angle belt. The zigzag belt 39 may be formed from using any of the zigzag patterns as described below. Preferably, the zigzag belt structure has 0.2 or more zigzag waves per drum revolution. The belt width of the zigzag belt is preferably in the range of about 70% to about 80% of the tread arc width, and even more preferably in the range of 73-77%. The zigzag belt 39 may be steel formed in a high elongation construction such as, for example, 3×7×0.22 HE, and having an EPI of about 14. The high elongation wire may have a % elongation at 10% of the breaking load ranging from about 1.7-2.05% for a bare, green cord. The high elongation wire may have a % elongation at 10% of the breaking load ranging from about 0.45-0.68% taken from cured tire. Another example of a cord construction suitable for the invention is made of steel having a 4×7×0.26 HE construction, with an EPI of 18.

Alternatively, the zigzag belt may be nonmetal. One example of a nonmetal cord which may be used is aramid, having a 1670/3 construction with a density of 24 EPI (ends per inch). The aramid may also have a 3300/3 construction with an EPI of 24. The % elongation at 10% of breaking load for a bare cord typically is 0.98%.

It is preferred that the zigzag belt be formed of a cord having a rigidity or stiffness which is defined as follows. The rigidity is analogous to a spring having an equation F=KX, wherein F is the force by unit of the transversal width of the strip (N/inch); K is the rigidity of force per transverse width divided by the % elongation in the longitudinal direction, (N/inch) and X is the relative % elongation in the longitudinal direction. Thus on a plot of force/transverse width vs. % relative elongation, the rigidity would equal the slope of the curve. It is desired to select a cord and cord density in the transversal direction (EPI) providing a strip rigidity in the range of about 300,000 N/inch to about 800,000N/inch, and more preferably in the range of about 350,000 to about 750,000 N/inch. The cord properties as described above are measured using a cord taken from a cured tire.

The aspect ratio of the tire described above may vary. The aspect ratio is preferably in the range of about 50 to about 90. The tire may have a net to gross ratio in the range of about 70 to about 90, more preferably in the range of about 74 to about 86, more preferably about 78 to 84.

### ZigZag Belt Construction

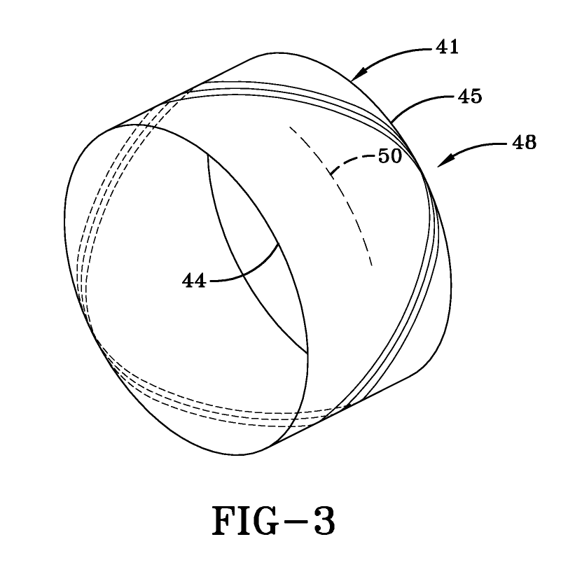

FIG. 3 illustrates a tire building drum 48 having axial circumferential edges 44, 45. In order to form the modified zigzag belt structure 39 on the tire building drum, the tire building drum is rotated as a rubberized strip 43 of cord is wound around the drum in a generally circumferential direction, extending in an alternating fashion from one drum edge 44 to the other drum edge 45.

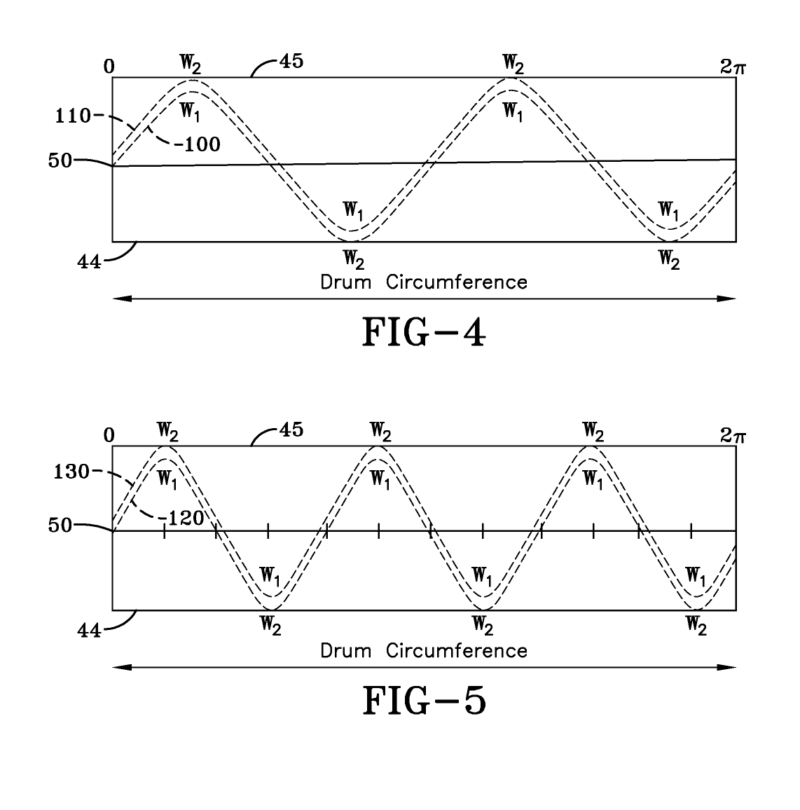

FIG. 4 illustrates the tire building drum wherein the circumference of the drum is laid out flat for illustration purposes, from 0 radians (degrees) to 2π radians (360 deg). A first winding 100 for a first drum revolution of the zigzag belt is shown. For illustration purposes, the initial starting point 50 will be the mid-circumferential centerplane of the drum at 0 radians, however any starting point location may be used. A strip of rubber having two or more reinforcement cords is wound on the drum from one side of the drum 45 to the other side in a wave pattern. As shown, there are two zigzag waves per drum circumference. The first strip winding 100 has a first amplitude W1 at the drum edge 45 and a second amplitude W2 at the other drum edge 44, wherein W2≠W1. The sequence of the first strip winding is continued, so that the winding has an amplitude W1 at 5/4π and then an amplitude of W2 at 7/4 π. Thus, the first winding has the following shorthand notation of the amplitude sequence: W2W1W2W1.

A second winding is then laid upon the drum. The strip may or may not be slightly indexed from the starting point 50. The second winding 110 has a first amplitude W2 at the drum edge 45, which is different than the amplitude of the first winding. The second winding has a second amplitude W1 at the drum edge 44, and the sequence continues so that the shorthand notation of the second winding is as follows: W1W2W1W2. The above sequence is repeated, indexing the starting point of the strip as needed so that the zigzag layer fully covers the drum in a uniform manner.

FIG. 5 illustrates a second embodiment of the invention wherein each zigzag winding 120, 130 has three waves per drum revolution (N=3). The first winding 120 has a zigzag pattern for L=2 and i=1 of W2W1 W2W1 W2W1, wherein W1 and W2 represent the amplitudes of the waves and wherein W1 is different than W2. The second winding 130 has a zigzag winding pattern (i=2) of W1W2 W1W2 W1W2. The above sequence is repeated, indexing the starting point of each strip winding as needed so that the zigzag layer fully covers the drum in a uniform manner.

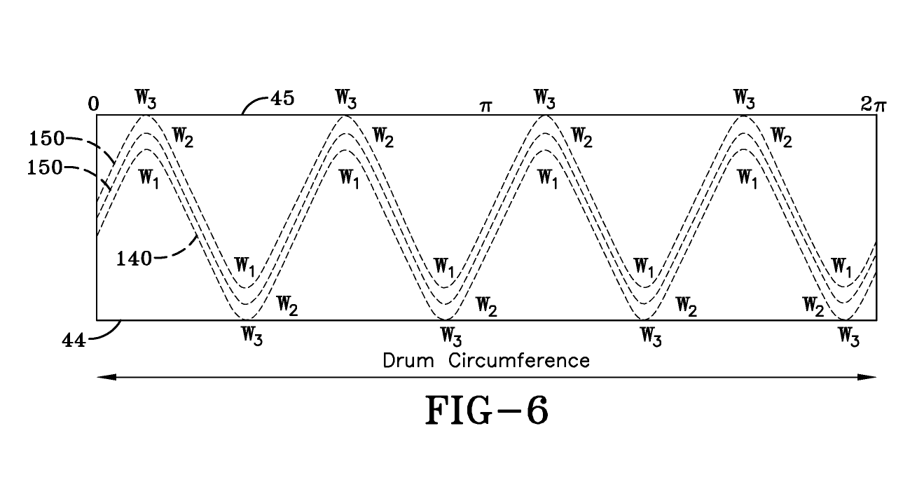

FIG. 6 illustrates a third embodiment of the invention wherein the zigzag layer is formed of a sequence of three different windings 140, 150, 160 wherein each winding has four waves per drum revolution (N=4). The First winding 140 (i=1) has the amplitude pattern W3W1 repeated four times over 1 drum revolution, or W3W1 W3W1 W3W1 W3W1. The second winding 150 (i=2) has the amplitude pattern W2W2 repeated four times, i.e., W2W2 W2W2 W2W2 W2W2 over 1 drum revolution. The third winding 160 has the amplitude pattern W1W3 repeated four times over 1 drum revolution, or W1W3 W1W3 W1W3 W1W3.

If N is the number of zigzags cycles per drum revolution and L is the number of different amplitudes used in the zigzag layer, then the sequence of amplitudes (W) defining a complete zigzag cycle per drum revolution is given by:
for i=1 to L,
W_{L-(i-1)}Wᵢ repeated N times for one drum revolution

N is the number of zigzag cycles per drum revolution and N is either an integer ≧1, i.e. 1, 2, 3, 4, 4, . . . or N=½ⁿ wherein n is an integer ≧1, i.e. N=½, ¼, ⅛, . . . .

This sub-sequence is repeated N times per winding. After the drum has done one revolution, the drum is preferably indexed a small rotation to offset the strip circumferentially. Then, i is incremented. A second sequence is determined and then repeated the number of times needed to fully complete the zigzag lay-up. L is preferably 2 or more.

The strip is formed of a rubberized ribbon of one or more cords. The width of the strip may vary, and may be for example, about 5-14 mm wide, and more preferably about 10-13 mm wide. The cord reinforcements may be formed of nylon, polyester, aramid or steel. The invention as described above may also abut the strips, thus having no gap in spacing of consecutive windings. Alternatively, the successive winding of strips may be overlapped from about 1% to about 100% of the strip width. Alternatively, the successive winding of strips may have a gap distance G formed therebetween. G may vary from about 1% to about 100% of the strip width.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising a tread, a carcass and a belt structure interposed between the carcass and the tread, wherein the belt structure includes a zigzag belt structure formed of at least two layers of cords interwoven together from a strip of rubber reinforced with one or more cords, wherein the strip forming the zigzag belt structure is layed up in a winding pattern in accordance with the following formula: for i=1 through L, the ith winding pattern is: [W_{L-(i-1)}Wᵢ]×N for each drum revolution, wherein L is the number of different amplitudes used to define the zigzag cycle and L≧2, and N is the number of zigzag cycles per drum revolution and N is an integer ≧1.

2. The tire of claim 1 wherein N>1.

3. A pneumatic tire comprising a tread, a carcass and a belt structure interposed between the carcass and the tread, wherein the belt structure includes a zigzag belt structure formed of at least two layers of cords interwoven together from a strip of rubber reinforced with one or more cords, wherein the strip forming the zigzag belt structure is layed up in a winding pattern in accordance with the following formula: for i=1 through L, the ith winding pattern is: [W_{L-(i-1)}Wᵢ]×N for each drum revolution, wherein L is the number of different amplitudes used to define the zigzag cycle and L≧2, and N is the number of zigzag cycles per drum revolution and N is N=½ⁿ wherein n is an integer ≧1.

4. The tire of claim 3 wherein n is >1.

5. A pneumatic tire comprising a tread, a carcass and a belt structure interposed between the carcass and the tread, wherein the belt structure includes a zigzag belt structure formed of at least two layers of cords interwoven together from a strip of rubber reinforced with one or more cords, wherein the strip forming the zigzag belt structure is layed up in a first zigzag winding pattern per drum revolution, wherein the first winding pattern has the sequence W2W1 repeated 2 times, wherein W1 is a first amplitude and W2 is a second amplitude different than the first amplitude, said zigzag belt structure further comprising a second winding pattern having the sequence W1W2 repeated 2 times.

6. A pneumatic tire comprising a tread, a carcass and a belt structure interposed between the carcass and the tread, wherein the belt structure includes a zigzag belt structure formed of at least two layers of cords interwoven together from a strip of rubber reinforced with one or more cords, wherein the strip forming the zigzag belt structure is layed up in a first zigzag winding pattern per drum revolution, wherein the first winding pattern has the sequence W3W1 and is repeated 4 times per drum revolution and a second winding pattern having a sequence W2W2 repeated 4 times per drum revolution, and a third winding pattern having a sequence W1W3 repeated 4 times per drum revolution, wherein W1 is a first amplitude and W2 is a second amplitude different than the first amplitude, and W3 is a third amplitude different than the first and second amplitude.

7. The pneumatic tire of claim 6 wherein N is 2.

8. The pneumatic tire of claim 6 wherein N is 3.

9. The pneumatic tire of claim 6 wherein the second zigzag winding abuts said first zigzag winding.

10. The pneumatic tire of claim 6 wherein the first and second zigzag windings each have turns at the first and second lateral edges, wherein the strip at each edge are extended in a circumferential direction for a distance H.

11. The pneumatic tire of claim 6 wherein the first zigzag winding is alternated with the second zigzag winding.

12. The pneumatic tire of claim 6 wherein the first zigzag winding is not alternated with the second zigzag winding.

13. The pneumatic tire of claim 6 wherein the belt at each edge extends in a substantially circumferential direction for a specified distance H.

14. The pneumatic tire of claim 6 wherein the zigzag belt structure has a first belt edge in a first winding, and a second belt edge in a second winding, wherein the midpoint of the first belt edge is circumferentially offset from the midpoint of the second belt edge.

15. The tire of claim 6 wherein the zigzag belt structure has a width about equal to the tread arc width.

16. The tire of claim 6 wherein the zigzag belt has a width in the range of about 75% to about 100% of the tread arc width.

17. The tire of claim 6 wherein the zigzag belt is formed of a cord having a % elongation at 10% of breaking load greater than 0.45%, when taken from wire from a cured tire.

18. The tire of claim 6 wherein the belt structure further includes two crossed working belts underlaying the zigzag belt.

19. The tire of claim 6 wherein the belt structure further includes two crossed working belts overlaying the zigzag belt.

20. The tire of claim 6 wherein the belt structure further includes a low angle belt, wherein the angle of the low angle belt is in a range of from 0 degrees to 10 degrees.

21. The tire of claim 20 wherein the low angle belt overlays the zigzag belt.

22. The tire of claim 20 wherein the low angle belt has a width of 50% to 80% of the zigzag belt structure.
